(19) United States
(12) Patent Application Publication
(10) Pub. No.: US 2023/0103228 A1
(43) Pub. Date: Mar. 30, 2023

(54) INDUCTION HEATING DEVICE AND METHOD FOR CONTROLLING INDUCTION HEATING DEVICE

(71) Applicant: LG ELECTRONICS INC., Seoul (KR)

(72) Inventors: Wongyu PARK, Seoul (KR); Bada YOON, Seoul (KR); John KANG, Seoul (KR)

(21) Appl. No.: 17/908,962

(22) PCT Filed: Feb. 23, 2021
(86) PCT No.: PCT/KR2021/002269

§ 371 Date: Sep. 2, 2022

(30) Foreign Application Priority Data
Mar. 4, 2020 (KR) 10-2020-0027407

(51) Int. Cl. H05B 6/06; H05B 6/12

(52) U.S. Cl. CPC H05B 6/062; H05B 6/1209

(57) ABSTRACT

The present disclosure relates to an induction heating device and a control method thereof. An induction heating device of one embodiment may comprise: an inverter circuit supplying electric currents to a working coil; a driving circuit supplying a switching signal to the inverter circuit, based on a control signal; an output detector detecting an output of the working coil; and a controller setting on-time of the working coil based on a current output of the working coil and controlling the output of the working coil, in a low-level operation in which a target output is equal to or less than a predetermined value.

### TECHNICAL FIELD

Disclosed herein are an induction heating device and a control method thereof.

### BACKGROUND ART

Methods in which a container is heated using electric energy include a resistance heating method and an induction heating method. In terms of the resistance heating method, heat energy is generated when electric current flows in a metallic resistance wire or a non-metallic heat generation element such as silicon carbide, the generated heat energy is delivered to a container, and the container is heated. In terms of the induction heating method, a magnetic field is generated around a working coil when electric energy is supplied to the working coil, eddy current is produced in a container by the magnetic field, and the container is heated.

An induction heating device heats a container based on the induction heating method. A working coil is disposed in a heating zone of the induction heating device, and performs induction heating based on a magnetic coupling with a coil built into a container.

To prevent damage to a switching element used for the induction heating device, the induction heating device uses switching frequencies within a limited range. That is, when the induction heating device operates at excessively high frequencies, the switching element of the induction heating device can be damaged. Since the operation at an excessively high frequency may cause damage to the switching element of the induction heating device, an upper limit frequency is set for the switching frequency.

Since various types of containers are used, the containers have different sizes and physical properties. Accordingly, even if the induction heating device operates at the same switching frequency, the output of the induction heating device varies depending on a container.

In particular, when the induction heating device operates in a low-level mode in which a target output is equal to or less than a predetermined value, since the switching frequency of the induction heating device is limited to the upper limit frequency, the output of the induction heating device varies depending on a container, and the induction heating device cannot provide heating performance desired by a user.

### DESCRIPTION OF INVENTION

### Technical Problems

According to one aspect, provided are an induction heating device and a control method thereof that can provide a target output constantly, regardless of the sort of a container for use, in a low-level operation in which the target output is equal to or less than a predetermined value.

According to another aspect, provided are an induction heating device and a control method thereof that can fix a switching frequency, adjust on-time and off-time of a working coil and provide a desired low-stage output accurately, in a low-level operation in which a target output is equal to or less than a predetermined value.

According to yet another aspect, provided are an induction heating device and a control method thereof that can adjust an on-off period to prevent off-time from occurring continuously, in a low-level operation in which a target output is equal to or less than a predetermined value, and can perform heating efficiently and reliably even at low temperature.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

### Technical Solutions

An induction heating device of one embodiment may comprise an inverter circuit supplying electric currents to a working coil, a driving circuit providing a switching signal to the inverter circuit, based on a control signal, an output detector detecting an output of the working coil, and a controller setting on-time of the working coil based on a current output of the working coil and controlling the output of the working coil, in a low-level operation in which a target output is equal to or less than a predetermined value.

In one embodiment, the controller may set an operation frequency of the inverter circuit to an upper limit frequency, and adjust the on-time of the working coil and control the output of the working coil, in the low-level operation.

In one embodiment, when the current output of the working coil is equal to or less than a predetermined critical output, the controller may determine the on-time, based on the target output and the critical output.

In one embodiment, the controller may apply a value calculated by dividing the target output by the critical output to an on-off period and determine the on-time.

In one embodiment, when the current output of the working coil is greater than the predetermined critical output, the controller may determine the on-time, based on the target output and the current output.

In one embodiment, the controller may apply a value calculated by dividing the target output by the current output to the on-off period and determine the on-time.

In one embodiment, the controller may reduce the on-off period while maintaining a ratio of the on-time to off-time in one period.

In one embodiment, when the determined on-time is equal to or less than a predetermined value, the controller sets the on-off period by dividing the on-off period by an integer while maintaining the ratio of the on-time to the off-time.

In one embodiment, a control method of an induction heating device may comprise confirming a low-level operation in which a target output is equal to or less than a predetermined value, detecting an output of a working coil, and setting on-time of the working coil, based on a current output of the working coil, and controlling the output of the working coil.

In one embodiment, controlling the output of the working coil may comprise setting an operation frequency of an inverter circuit to an upper limit frequency, and comparing the current output of the working coil with a predetermined critical output and setting a determination method of the on-time.

In one embodiment, determining the on-time may comprise determining the on-time based on the target output and the critical output, when the current output of the working coil is equal to or less than a predetermined critical output.

In one embodiment, determining the on-time may comprise applying a value calculated by dividing the target output by the critical output to an on-off period and determining the on-time, when the current output of the working coil is equal to or less than a predetermined critical output.

In one embodiment, determining the on-time may comprise determining the on-time, based on the target output and the current output, when the current output of the working coil is greater than the predetermined critical output, and controlling the output of the working coil comprises applying a value calculated by dividing the target output by the current output to the on-off period and determining the on-time, when the current output of the working coil is greater than the predetermined critical output.

In one embodiment, determining the on-time may further comprise reducing the on-off period while maintaining a ratio of the on-time and off-time in one period.

In one embodiment, determining the on-time may further comprise setting the on-off period by dividing the on-off period by an integer, while maintaining the ratio of the on-time and the off-time, when the determined on-time is equal to or less than a predetermined value.

### Advantageous Effects

According to the present disclosure, in a low-level operation in which a target output is equal to or less than a predetermined value, the target output can be provided constantly regardless of the sort of a container for use.

According to the present disclosure, in a low-level operation in which a target output is equal to or less than a predetermined value, a switching frequency can be fixed, on-time and off-time of a working coil can be adjusted, and a desired low-stage output can be provided accurately.

According to the present disclosure, in a low-level operation in which a target output is equal to or less than a predetermined value, an on-off period can be adjusted, off-time can be prevented from occurring continuously, and even at low temperature, heating can be performed efficiently and reliably.

### BRIEF DESCRIPTION OF DRAWINGS

FIG. 1 is an exploded perspective view showing an induction heating device of one embodiment.

FIG. 2 is a block diagram showing the induction heating device of one embodiment.

FIG. 3 is a graph showing a relationship between switching frequencies and outputs of an induction heating device, based on the type of a container.

FIG. 4 is a view for describing an on-time adjustment of a controller, in one embodiment.

FIG. 5 is a view for describing the adjustment of an on-off period, in one embodiment.

FIG. 6 is a flowchart describing a control method of an induction heating device of one embodiment.

FIG. 7 is a flowchart describing one embodiment of step 630 in FIG. 6.

### DETAILED DESCRIPTION OF EXEMPLARY EMBODIMENTS

The above-described aspects, features and advantages are specifically described hereafter with reference to the accompanying drawings such that one having ordinary skill in the art to which the present disclosure pertains can easily embody the technical spirit of the disclosure.

Embodiments can be modified and changed in various different forms and are not limited to the embodiments set forth herein. Hereafter, specific embodiments are illustrated in the drawings and described in detail. However, the subject matter of the disclosure is not limited by the embodiments herein, and all modifications, equivalents or replacements within the scope of the disclosure should be construed as being included in the scope of the disclosure.

For example, a first component can be referred to as a second component, and similarly, the second component can be referred to as the first component without departing from the scope of the right to the subject matter of the present disclosure.

The term “and/or” can imply the combination of a plurality of relevant stated items or any one of the plurality of relevant stated items.

When any one component is described as “connecting” or “connecting” to another component, any one component can directly connect or connect to another component, but an additional component can be “interposed” between the two components. When any one component is described as “directly connecting” or “directly connecting” to another component, an additional component is not “interposed” between the two components.

The terms in the disclosure are used only to describe specific embodiments and not intended to limit the subject matter of the disclosure. In the disclosure, singular forms include plural forms as well, unless explicitly indicated otherwise.

It is to be understood that the terms such as “comprise” or “have” and the like, when used in this disclosure, are not interpreted as necessarily including stated components or steps, but can be interpreted as excluding some of the stated components or steps or as further including additional components or steps. In the disclosure, the terms “comprise” or “have” and the like specify the presence of stated features, integers, steps, operations, elements, components or combinations thereof but do not imply the exclusion of the presence or addition of one or more other features, integers, steps, operations, elements, components or combinations thereof.

Unless otherwise defined, all the terms including technical or science terms) used herein have the same meaning as commonly understood by one of ordinary skill in the art. Additionally, terms such as those defined in commonly used dictionaries should be interpreted as having a meaning that is consistent with their meaning in the context of the relevant art, and unless explicitly defined herein, should not be interpreted in an ideal or overly formal way.

The embodiments described hereafter are provided as examples so that the present disclosure can fully convey the subject matter of the present disclosure to one having ordinary skill in the art. Further, the shape and sizes of the components in the drawings can be exaggerated for clarity of description.

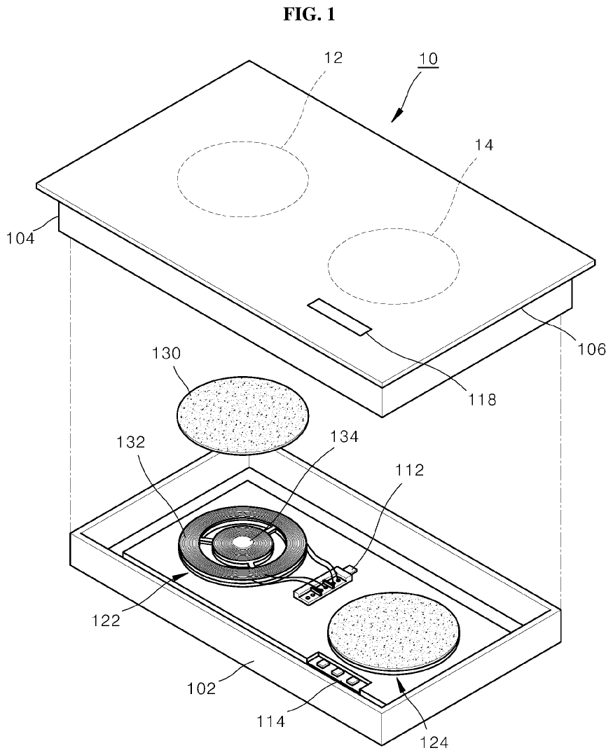

FIG. 1 is an exploded perspective view showing an induction heating device of one embodiment.

Referring to FIG. 1, the induction heating device 10 of one embodiment comprises a case 102 constituting a main body, and a cover plate 104 being coupled to the case 102 and sealing the case 102.

The cover plate 104 is coupled to the upper surface of the case 102 and seals a space formed in the case 102 from the outside. The cover plate 104 comprises an upper plate 106 on which a container for cooking a food item can be placed. In one embodiment, the upper plate 106 may be made of tempered glass such as ceramic glass. However, the material for the upper plate 106 may vary depending on embodiments.

A heating zone 12, 14 corresponding to each working coil assembly 122, 124 is formed on the upper plate 106. For the user to recognize the position of the heating zone 12, 14 clearly, a line or a figure corresponding to the heating zone 12, 14 may be printed or displayed on the upper plate 106.

The case 102 may have a cuboid shape the upper portion of which is open. The working coil assembly 122, 124 for heating a container is disposed in the space formed in the case 102. The case 102 has an interface part 114, therein, and the interface part 114 performs the function of allowing a user to supply a power source or adjust the output of the working coil assembly 122, 124 and the function of displaying information on the induction heating device 10. The interface part 114 may be embodied as a touch panel enabling a touch-based input and display of information, but depending on embodiments, an interface part 114 having a different structure may be used.

Additionally, a manipulation zone 118 is disposed in a position corresponding to the position of the interface part 114, on the upper plate 106. For the user's manipulation, characters or images and the like may be printed in the manipulation zone 118, in advance. The user may perform a desired manipulation by touching a specific point of the manipulation zone 118 with reference to the characters or the images that are printed in advance in the manipulation zone 118. Additionally, information output by the interface part 114 may be displayed through the manipulation zone 118.

Further, a power supply part 112 for supplying power to the working coil assembly 122, 124 or the interface part 114 is disposed in the space formed in the case 102.

In the embodiment of FIG. 1, two working coil assemblies 122, 124 are disposed in the case 102, for example. However, depending on embodiments, one working coil assembly or two or more working coil assemblies may be disposed in the case 102.

The working coil assembly 122, 124 comprises a heat insulation sheet for protecting a coil from heat that is generated by a working coil forming an induction field, with high-frequency AC currents supplied by the power supply part 112, and by a container. For example, in FIG. 1, a first working coil assembly 122 comprises a first working coil 132 for heating a container placed in a first heating zone 12, and a first heat insulation sheet 130. Though not illustrated, a second working coil 124 comprises a second working coil and a second heat insulation sheet. Depending on embodiments, a heat insulation sheet may be excluded.

Additionally, although not shown in FIG. 1, a substrate on which a plurality of circuits or elements including a controller and a protection circuit are mounted may be disposed in the space formed in the case 102. The controller receives the user's instruction through the interface part 114, and according to the user's instruction, controls the driving of a working coil to perform the operation of heating a container.

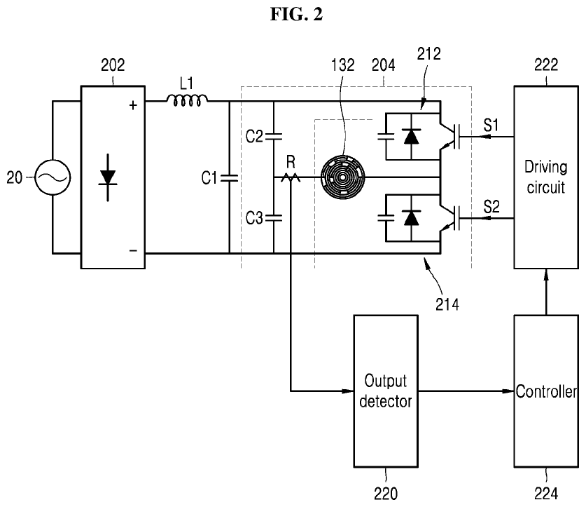

FIG. 2 is a block diagram showing the induction heating device of one embodiment.

Referring to FIG. 2, the induction heating device 10 of one embodiment comprises a rectifying circuit 202, a smoothing circuit L, C1, an inverter circuit 204, a working coil 132, a controller 224, and a driving circuit 222.

The rectifying circuit 202 rectifies an AC input voltage supplied from an input power source 20 and outputs a voltage having a pulse waveform.

The smoothing circuit L, C1 smoothes the voltage rectified by the rectifying circuit 202 and outputs a DC link voltage. The smoothing circuit L, C1 may comprise an inductor L, and a DC link capacitor C1. The illustrated example shows an LC smoothing circuit. However, depending on embodiments, various types of smoothing circuits may be applied.

The inverter circuit 204 converts the DC lick voltage output from the smoothing circuit L, C1 to an AC voltage for driving the working coil 132. The inverter circuit 204 may comprise a first capacitor C2, a second capacitor C3, a first switching element 212, and a second switching element 214. The illustrated example shows an inverter circuit using two switching elements. However, depending on embodiments, various types of inverter circuits may be applied.

The first switching element 212 and the second switching element 214 included in the inverter circuit 204 are turned on/off alternately by a first inverter driving signal S1 and a second inverter driving signal S2 that are output from the driving circuit 222. The first inverter driving signal S1 and the second inverter driving signal S2 respectively may be pulse-width modulation signals having a predetermined duty ratio. As the first inverter driving signal S1 and the second inverter driving signal S2 are provided respectively to the first switching element 212 and the second switching element 214, the DC link voltage is converted to an AC voltage while the first switching element 212 and the second switching element 214 are turned on/off alternately.

The AC voltage generated by the inverter circuit 204 is supplied to the working coil 132. As the AC voltage is supplied, the working coil 132 operates. As the working coil 132 operates, eddy current flows in a container placed on the working coil 132, the container is heated. The magnitude of thermal energy supplied to the container varies depending on the magnitude of power that is generated by the working coil 132 as the working coil 132 operates, i.e., the output power of the working coil.

The controller 224 determines a driving frequency of the inverter circuit 204, i.e., a switching frequency of the switching element, and supplies a control signal DS corresponding to the determined switching frequency to the driving circuit 222.

As the user turns on (powers on) the induction heating device by manipulating a control interface of the induction heating device, power is supplied from the input power source 20 to the induction heating device, and the induction heating device is put on standby for driving. Then the user places a container on the working coil 132 of the induction heating device, and gives an instruction to initiate heating to the working coil 132 by setting a heating level for the container. As the user gives the instruction to initiate heating, output power, i.e., target power, required of the working coil 132 is determined based on the heating level set by the user.

Having received the user's instruction to initiate heating, the controller 224 sets a driving frequency corresponding to the required power value and supplies a control signal corresponding to the set driving frequency to the driving circuit 222. Accordingly, as the first inverter driving signal S1 and the second inverter driving signal S2 are output from the driving circuit 222, the working coil 132 operates. As the working coil 132 operates, the container is heated while eddy current flows in the container.

An output detector 220 detects an output of the working coil 132. For example, the output detector 220 may detect current input to the working coil 132 by using resistance R, and based on the detected current, calculate the output of the working coil 132. In addition to the example, the output detector 220 may detect the output of the working coil 132 by using various methods, depending on embodiments.

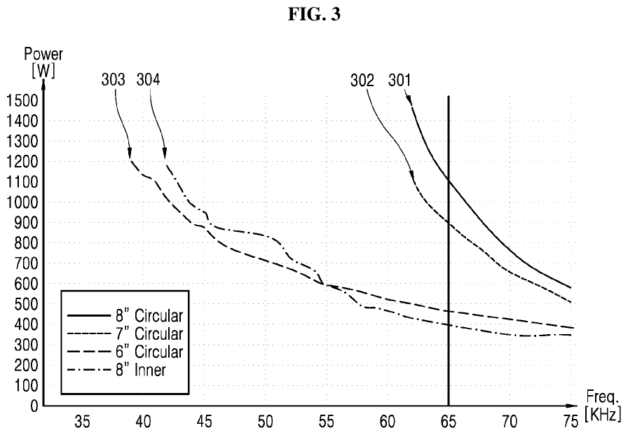

FIG. 3 is a graph showing a relationship between switching frequencies and outputs of the induction heating device, based on the type of a container. FIG. 3 shows a relationship between switching frequencies and outputs for the four types of containers.

Hereafter, the operation of the controller is described with further reference to FIG. 3.

The controller 224 may control the output of the working coil 132 by adjusting the switching frequency of the inverter circuit 204. As illustrated in FIG. 3, regardless of the type of a container, as the switching frequency becomes lower, the output becomes higher, and as the switching frequency becomes higher, the output becomes lower.

Accordingly, when the user inputs a high output, i.e., in a high-level operation, the controller 224 may lower the switching frequency to provide an output required by the user.

In one embodiment, the controller 224 may drive the working coil 132 at a specific switching frequency, and at this time, confirm a current output detected by the output detector 220 to find out properties of a container. For example, if the detected output is 1130 W when the controller 224 sets the switching frequency to 40 KHz and drives the working coil 132, the controller 224 may determine that the container corresponds to a 6-inch circular container 303, and during the following control, adjust the switching frequency based on properties of the 6-inch circular container. Accordingly, the controller 224 may be provided in advance with data on the switching frequency and output properties of the each container, and identify the container, based on the property data.

When the user inputs a low output, that is, in a low-level operation in which the target output is equal to or less than a predetermined value, the controller 224 may set the on-time of the working coil 132, based on a current output of the working coil 132, and control the output of the working coil. Hereafter, description is provided under the assumption that the target output of 600 W or less is a low-level operation only as an example, but not limited.

Specifically, to prevent the damage to the switching element 212, 214 of the inverter circuit 204, the induction heating device uses switching elements in a limited range. That is, an operation at an excessively high frequency may result in the damage to the switching element of the induction heating device. To prevent the damage, the controller 224 sets an upper limit frequency of the switching frequencies, and operates the working coil. In the example of FIG. 3, the controller 224 may set the upper limit frequency to 65 KHz. Depending on the type of a container, even if the working coil is driven at the upper limit frequency, an enough output may not be ensured. Since the target output is equal to or less than 600 W in the low-level operation, an 8-inch circular container 301 and a 7-inch circular container 302 in FIG. 3 have a minimum output of 1100 W and 900 W respectively, even if the 8-inch circular container 301 and the 7-inch circular container 302 are driven at the upper limit frequency of 65 KHz. The controller 224 may turn on-off the working coil 132 in one period to obtain a desired target output, and provide the desired output. Since the on-time is set differently depending on the type of a container, the controller 224 may set the on-time of the working coil 132, based on a current output of the working coil 132.

In one embodiment, the controller 224 may set the operation frequency of the inverter circuit 204 to the upper limit frequency in the low-level operation, and adjust the on-time of the working coil, to control the output. For example, in FIG. 3, the controller 224 drives the working coil 132 at the operation frequency that is the upper limit frequency of 65 KHz, and as the current output of the working coil 132 exceeds 600 W, sets the on state and the off state of the working coil 132 alternately in a signal period to adjust the output.

In another embodiment, when the output of the working coil 132 is equal to or less than a predetermined critical output in the case of an operation frequency of the inverter circuit 204, which is set to the upper limit frequency, i.e., when the output of the working coil 132 is 600 W or less as described in the above example, the controller 224 adjusts the switching frequency such that the output of the working coil 132 can corresponds to the critical output of 600 W. In the example of FIG. 3, when the operation frequency of the inverter circuit 204 is set to the upper limit frequency of 65 KHz, the switching frequency is adjusted to 55 KHz to set the output to 600 W in relation to the 6-inch circular container 303 and the 8-inch inner container 304 where the output of the working coil 132 is 600 W or less. After the output is set to 600 W, the on-time of the working coil 132 is adjusted to ensure a desired output.

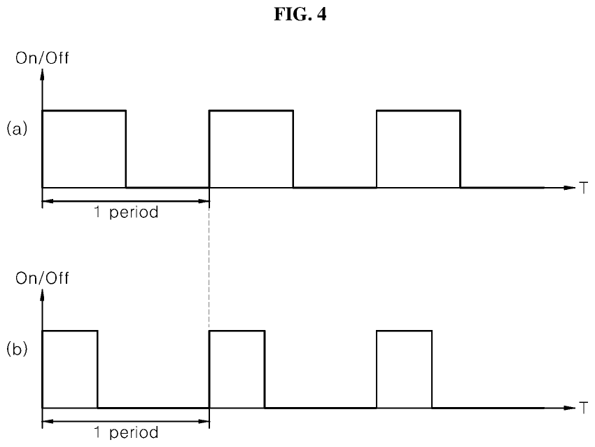

FIG. 4 is a view for describing an on-time adjustment of a controller, in one embodiment. Hereafter, the on-time control of the controller is described with further reference to FIG. 4.

In one embodiment, when a current output of the working coil 132 is equal to or less than a predetermined critical output, the controller 224 may determine on-time based on the target output and the critical output.

For example, the controller 224 may determine on-time by using formula 1.

$$\frac{Target output}{Critical output} * 1 period \qquad [ Formula 1 ]$$

For example, suppose that a critical output is a maximum output of 600 W in the low-level operation, that a target output input by the user is 300 W, that a current output of the working coil 132 is 600 W and that the time of one period is 3 seconds. The controller 224 may determine on-time, based on the target output of 300 W and the critical output of 600 W, because the current output of the working coil 132 is 600 W. That is, when a value calculated by dividing the target output 300 W by the critical output 600 W is applied to the on-off period of 3 seconds, the on-time is 1.5 seconds. For 1.5 seconds that is half of one period, the working coil 132 is driven at 600 W (On-time), and for the remaining 1.5 seconds, the working coil 132 is not driven (Off-time). Thus, in one period, a total of 300 W is output. The on-time and off-time in the example are illustrated in FIG. 4(a).

In one embodiment of the present disclosure, when the current output of the working coil 132 exceeds the predetermined critical output, the controller 224 may determine the on-time, based on the target output and the current output.

For example, the controller 224 may determine on-time by using formula 2.

$$\frac{Target output}{Current output} * 1 period \qquad [ Formula 2 ]$$

For example, supposed that a critical output is the maximum output of 600 W in the low-level operation, that a target output input by the user is 300 W, that a current output of the working coil 132 is 900 W and that the time of one period is 3 seconds, like those of the 7-inch container of FIG. 3. The controller 224 may determine on-time, based on the target output of 300 W and the current output of 900 W, because the current output of the working coil 132 is 900 W. That is, a value calculated by dividing the target output of 300 W by the current output of 900 W is applied to the on-off period of 3 seconds, the on-time is 1 second. Accordingly, for 1 second in one period, the working coil 132 is driven at 900 W (On-time), and for the remaining 2 seconds, the working coil 132 is not driven (Off-time). Thus, in one period, a total of 300 W is output. The on-time and off-time in the example are illustrated in FIG. 4(b).

That is, when a switching frequency is set to the upper limit frequency of 65 KHz, a current output may exceed the critical output depending on the type of a container. At this time, the current output, instead of the critical output, is used to set on-time. Then the output is controlled accurately. When formula 1 rather than formula 2 is applied, the current output is 900 W, the on-time is 1.5 seconds, and an actual output is 450 W. The actual output is increased by 150 W from the actual target output of 300 W. Thus, when the current output exceeds the critical output, the controller 224 sets the on-time by using formula 2, to control temperature accurately.

In one embodiment, the controller 224 may reduce the on-off period while maintaining a ratio of the on-time to the off-time in one period, such that the off-time period is prevented from being maintained for a predetermined time or greater.

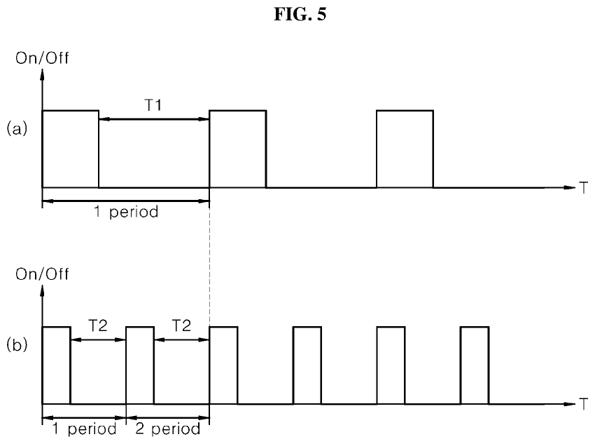

FIG. 5 is a view for describing the adjustment of an on-off period, in one embodiment. Hereafter, the controller's control of the on-off period is described with further reference to FIG. 5.

Like FIG. 4(b), FIG. 5(a) shows that on-time is 1 second and off-time is 2 seconds in one period of on-time of 3 seconds. In this operation, actually, the heating operation is not performed for the off-time T1 of 2 seconds. Accordingly, a food item may cool or heating efficiency may deteriorate. To prevent the off-time period from being maintained for the predetermined time or greater, the controller 224 may reduce the on-off period while maintaining a ratio of the on-time to the off-time in one period as shown in FIG. 5(b).

The controller 224 may increase the on-time and off-time that are repeated once in one period by an integer. That is, the on-off period may be divided by an integer and set. FIG. 5(b) shows that the on-off period is divided by two such that one period is 1.5 seconds. Accordingly, in one period, i.e., for three seconds, the controller 224 may control the on-time and the off-time such that the on-time of 0.5 second and the off-time T2 of 1 second are repeated twice. Based on the control, unlike the off-time T1 maintained for 2 seconds in FIG. 5(a), the off-time T2 in FIG. 5(b) is 1 second, and in the midst, the on-time occurs. Thus, during cooking, a food item is prevented from cooling, and heating efficiency may improve.

In one embodiment, when the on-time is equal to or less than a predetermined value, the controller 224 may divide the on-off period by an integer while maintaining a ratio of the on-time to the off-time. For example, when the on-time is equal to or less than 50% in one period, the controller 224 may reduce the on-off period as shown in FIG. 5(b), and when the on-time is greater than 50% in one period, the controller 224 may not change the on-off period. In the above-described example, the embodiment has been described using a value of 50% as an example, but the present invention is not limited thereto. In addition, various modifications may be made, such as an on-off period being adjusted when the off-time lasts for a predetermined time or more.

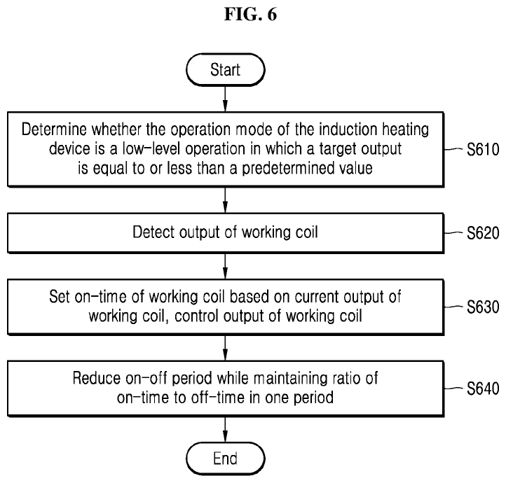

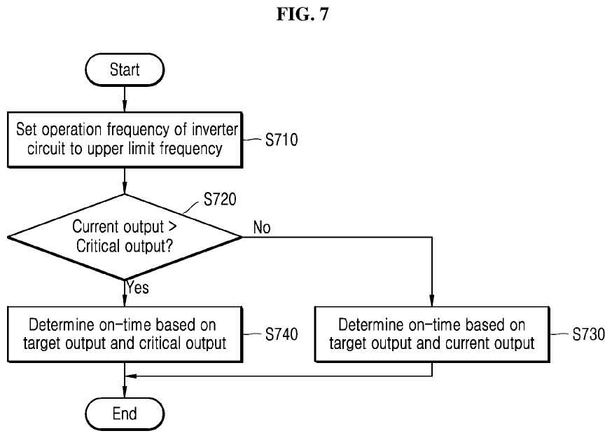

In the above description, the induction heating device of one embodiment is described with reference to FIGS. 1 to 5. Hereafter, a control method of an induction heating device of one embodiment is described with reference to FIGS. 6 to 7. The control method of an induction heating device, described hereafter, is performed by the induction heating device described above. Accordingly, the control method can be easily understood with reference to the above description that is provided with reference to FIGS. 1 to 5.

FIG. 6 is a flowchart describing a control method of an induction heating device of one embodiment.

Referring to FIG. 6, a controller 224 may determine whether the operation mode of the induction heating device is a low-level operation in which a target output is equal to or less than a predetermined value (S610).

The controller 224 may detect an output of a working coil (S620), and based on a current output of the working coil, set on-time of the working coil and control the output of the working coil (S630).

In one embodiment of step 630 (S630), the controller 224 sets an operation frequency of an inverter circuit to an upper limit frequency, and compare the current output of the working coil with a predetermined critical output and set a determination method of the on-time.

FIG. 7 is a flowchart describing one embodiment of step 630 (S630) in FIG. 6, and hereafter, detailed description is provided with reference to FIG. 7.

In one embodiment, the controller 224 may set the operation frequency of the inverter circuit to the upper limit frequency (S710). Then the controller 224 may compare the current output of the working coil with the predetermined critical output (S720), and set the determination method of the on-time (S730, S740).

That is, when the current output of the working coil is the critical output or less (S720, No), the controller 224 may determine the on-time, based on the target output and the critical output (S730). For example, when the current output of the working coil is the critical output or less, the controller 224 may apply a value calculated by dividing the target output by the critical output to an on-off period and determine the on-time.

When the current output of the working coil is greater than the critical output (S720, Yes), the controller 224 may determine the on-time, based on the target output and the current output (S740). For example, when the current output of the working coil is greater than the critical output, the controller 224 may apply a value calculated by dividing the target output by the current output to the on-off period and determine the on-time.

In one embodiment, the controller 224 may reduce the on-off period while maintaining a ratio of the on-time to off-time in one period (S640).

For example, when the determined on-time is equal to or less than a predetermined value, the controller 224 may divide the on-off period by an integer while maintaining the ratio of the on-time to the off-time.

The embodiments are described above with reference to a number of illustrative embodiments thereof. However, embodiments are not limited to the embodiments and drawings set forth herein, and numerous other modifications and embodiments can be drawn by one skilled in the art within the technical scope of the disclosure. Further, the effects and predictable effects based on the configurations in the disclosure are to be included within the range of the disclosure though not explicitly described in the description of the embodiments.

1. An induction heating device, comprising:
an inverter circuit supplying electric currents to a working coil;
a driving circuit providing a switching signal to the inverter circuit, based on a control signal;
an output detector detecting an output of the working coil; and
a controller setting on-time of the working coil based on a current output of the working coil and controlling the output of the working coil, in a low-level operation in which a target output is equal to or less than a predetermined value.

2. The induction heating device of claim 1, wherein the controller sets an operation frequency of the inverter circuit to an upper limit frequency, and adjusts the on-time of the working coil and controls the output of the working coil, in the low-level operation.

3. The induction heating device of claim 2, wherein when the current output of the working coil is equal to or less than a predetermined critical output, the controller determines the on-time, based on the target output and the critical output.

4. The induction heating device of claim 3, wherein the controller applies a value calculated by dividing the target output by the critical output to an on-off period and determines the on-time.

5. The induction heating device of claim 2, wherein when the current output of the working coil is greater than a predetermined critical output, the controller determines the on-time, based on the target output and the current output.

6. The induction heating device of claim 5, wherein the controller applies a value calculated by dividing the target output by the current output to an on-off period and determines the on-time.

7. The induction heating device of claim 1, wherein the controller reduce an on-off period while maintaining a ratio of the on-time to off-time in one period.

8. The induction heating device of claim 7, wherein when the determined on-time is equal to or less than a predetermined value, the controller divide the on-off period by an integer while maintaining the ratio of the on-time to the off-time.

9. A control method of an induction heating device, comprising:
determining whether the operation mode of the induction heating device is a low-level operation in which a target output is equal to or less than a predetermined value;
detecting an output of a working coil; and
setting on-time of the working coil, based on a current output of the working coil, and controlling the output of the working coil.

10. The control method of claim 9, controlling the output of the working coil, comprising:
setting an operation frequency of an inverter circuit to an upper limit frequency; and
comparing the current output of the working coil with a predetermined critical output and setting a determination method of the on-time.

11. The control method of claim 10, wherein controlling the output of the working coil, comprising:
determining the on-time, based on the target output and the critical output, when the current output of the working coil is equal to or less than a predetermined critical output.

12. The control method of claim 11, wherein controlling the output of the working coil comprises applying a value calculated by dividing the target output by the critical output to an on-off period and determining the on-time, when the current output of the working coil is equal to or less than a predetermined critical output.

13. The control method of claim 10, wherein controlling the output of the working coil, comprising:
determining the on-time, based on the target output and the current output, when the current output of the working coil is greater than the predetermined critical output; and
applying a value calculated by dividing the target output by the current output to an on-off period and determining the on-time, when the current output of the working coil is greater than the predetermined critical output.

14. The control method of claim 9, wherein the control method further comprises reducing an on-off period while maintaining a ratio of the on-time and off-time in one period.

15. The control method of claim 14, wherein reducing an on-off period comprises dividing the on-off period by an integer, while maintaining the ratio of the on-time and the off-time, when the determined on-time is equal to or less than a predetermined value.
